(19) United States
(12) Patent Application Publication
(10) Pub. No.: US 2026/0321451 A1
(43) Pub. Date: Oct. 15, 2026

(54) RADIOPHARMACEUTICAL PREPARATION CONTAINMENT SYSTEM

(71) Applicant: The Board of Regents of the University of Oklahoma, Norman, OK (US)

(72) Inventors: Wendy Galbraith, Norman, OK (US); Colton Wamsley, Enid, OK (US); Francisco Robles, Rio Rico, AZ (US); Brandt Smith, Moore, OK (US)

(73) Assignee: The Board of Regents of the University of Oklahoma, Norman, OK (US)

(21) Appl. No.: 19/328,522

(22) Filed: Sep. 15, 2025

Related U.S. Application Data
(60) Provisional application No. 63/694,270, filed on Sep. 13, 2024.

(51) Int. Cl. G21F 7/04; G21F 1/10; G21F 5/00

(52) U.S. Cl. CPC G21F 7/04; G21F 1/10; G21F 5/00

(57) ABSTRACT

A radionuclide containment system is configured to prevent the escape of radioactive contaminants during a radiopharmaceutical preparation process. The radionuclide containment system generally includes an acrylic enclosure that is formed by the collection of a back panel, a right side panel, a left side panel, a top panel and a bottom panel. The radionuclide containment system includes an access panel that can be opened to provide access to an enclosure interior through an enclosure opening. The access panel can be latched into a closed, sealed position. The radionuclide containment system further includes a filter system that includes one or more filters that include a filter media, such as activated carbon. The filters vent pressurized gases from the interior of the enclosure, while absorbing radioactive particles. The radionuclide containment system can also include a hermetically sealed power port for providing electrical power to equipment located inside the enclosure.

### RELATED APPLICATIONS

The present application claims the benefit of United States Provisional Patent Application Ser. No. 63/694,270 filed Sep. 13, 2024 entitled, “Radiopharmaceutical Preparation Containment System,” the disclosure of which is incorporated by reference as if fully set forth herein.

### BACKGROUND

Radiopharmaceuticals are short lived radioactive pharmaceuticals that must be prepared the day of administration or just prior to administration. The prepared radiopharmaceutical must undergo quality control (QC) testing for purity before it is administered to the patient because of potential for radiochemical impurities. QC is a subdivision or form of quality assurance that focuses on evaluation of the material and products (i.e., radiopharmaceutical preparations) for minimum acceptance standards specified by the United States Pharmacopeia (USP), and specifications approved by the Food and Drug administration (FDA) of a products chemistry, manufacturing, and controls (CMC). These standards and specifications are derived from radiopharmaceutical manufacturers and scientific literature. If the radiochemical purity is below industry standards, unexpected patterns of radiopharmaceutical biodistribution will put a patient at risk for increased radiation exposure, potential misdiagnosis and delayed treatment.

The primary responsibility for the quality of the radiopharmaceutical rests with the manufacturer, but it is the responsibility of the end user to verify quality control to ensure the purity of the preparation before patient administration. The State Board of Pharmacy, the NRC or state agreement agency, and the FDA can all regulate radiopharmaceuticals which are sterile and non-sterile drugs. It is indirectly regulated by reimbursement providers through accreditation agencies like The Joint Commission. Improper administrations and adverse events may be investigated by the end user's institution e.g., safety board, the NRC, and the FDA if the situation causes substantial harm. The United States Pharmacopeia General Chapter on Radiopharmaceuticals requires end product radiochemical purity documentation for each radiopharmaceutical administered.

Radiopharmaceuticals are routinely prepared and handled in specialized facilities. These preparations often involve heating sealed vials containing medical radionuclides, which can potentially lead to pressure buildup and, in rare cases, vial breakage. The release of pressurized, hot radionuclides creates a contamination risk that should be contained. Existing containment solutions, such as ‘shield glove boxes’, have permanent openings for hand and arm entry that cannot be fully sealed, potentially allowing the escape of airborne radioactive contamination. Other containment systems, like enclosures with aquarium-like lids, do not provide complete containment and may not meet cleanroom requirements for non-porous, easily cleanable surfaces.

In each case, existing containment enclosures are made of 6 mm (0.5 in) acrylic plates and contain a negative pressure fan that pulls the air continuously out of the enclosure through a carbon filter. The enclosure is designed for handling radioactive iodine and must be located inside of a chemical, negative pressure, charcoal-scrubbed hood. These containment systems are not designed for a cleanroom installation because it alters the unidirectional airflow of the space in front of the glove box. In addition, existing containment systems include a motor which generates particulates that may contaminate radiopharmaceutical samples.

In the event of vial explosion during heating or other preparation activities, current containment practices involve closing off the affected area for several days to allow for radiation decay. This may result in significant downtime, with the potential for contamination of surrounding areas. There is a need for a containment solution that can effectively mitigate these risks while meeting cleanroom standards and minimizing operational disruptions.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function.

FIG. 1 is a front perspective view of a radionuclide containment system constructed in accordance with an exemplary embodiment.

FIG. 2 is a front view of the radionuclide containment system of FIG. 1.

FIG. 3 is a right side view of the radionuclide containment system of FIG. 1.

FIG. 4 is a left side view of the radionuclide containment system of FIG. 1.

FIG. 5 is a rear view of the radionuclide containment system of FIG. 1.

### DETAILED DESCRIPTION

In exemplary embodiments, the present disclosure is directed to a radionuclide containment system 100 that is well-suited for use in connection with the preparation of radiopharmaceuticals. In the depicted embodiments, the radionuclide containment system 100 is configured as a gloveless enclosure with a hinged front door that can be opened to provide access to radiopharmaceutical preparation equipment located inside the radionuclide containment system 100. The front door can be closed and latched into a locked position to prevent the unintended release of radioactive materials from the radionuclide containment system 100. The radionuclide containment system 100 includes an integrated filter system that provides a passive mechanism for safely venting pressurized gases that accumulate inside the radionuclide containment system 100. The disclosed radionuclide containment system 100 further includes a sealed power port for carrying electrical power to as heating devices and other equipment located inside the radionuclide containment system 100.

Before further describing various embodiments of the present disclosure in more detail by way of exemplary description, examples, and results, it is to be understood that the embodiments of the present disclosure are not limited in structure and application to the details as set forth in the following description. The embodiments of the present disclosure are capable of being practiced or carried out in various ways not explicitly described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. While the present disclosure has been described in terms of particular embodiments, it will be apparent to those of skill in the art that variations may be applied to the apparatus and/or methods and in the steps or in the sequence of steps of the methods described herein without departing from the concept, spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference in their entirety to the same extent as if the contents of each individual patent or publication was specifically and individually incorporated herein.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the apparatus, methods and compositions of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the terms “at least one” or “plurality” will be understood to include one as well as any quantity more than one, including but not limited to, 2, 3, 4, 5, 6, 7, 8, 9, 10, 15, 20, 30, 40, 50, 100, or any integer inclusive therein, and/or any range described herein. The terms “at least one” or “plurality” may extend up to 100 or 1000 or more, depending on the term to which it is attached; in addition, the quantities of 100/1000 are not to be considered limiting, as higher limits may also produce satisfactory results. In addition, the use of the term “at least one of x, y and z” will be understood to include x alone, y alone, and z alone, as well as any combination of x, y and z.

Where the specification or claims refer to “an additional” element, that does not preclude there being more than one of the additional element. It is to be understood that where the claims or specification refer to “a” or “an” element, such reference is not to be construed that there is only one of that element. It is to be understood that where the specification states that a component, feature, structure, or characteristic “may,” “might,” “can” or “could” be included, that particular component, feature, structure, or characteristic is not required to be included.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “a, b, c, or combinations thereof” is intended to include at least one of: a, b, c, ab, ac, bc, or abc, and if order is important in a particular context, also ba, ca, cb, cba, bca, acb, bac, or cab. Continuing with this example, expressly included are combinations that contain repeats of one or more item or term, such as bb, aaa, aab, bbc, aaabcccc, cbbaaa, cababb, and so forth. The skilled artisan will understand that typically there is no limit on the number of items or terms in any combination, unless otherwise apparent from the context.

Throughout this application, the terms “about” and “approximately” are used to indicate that a value includes the inherent variation of error for the composition, the method used to administer the composition, or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example. The terms “about” or “approximately”, where used herein when referring to a measurable value such as an amount, a temporal duration, thickness, width, length, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that the subsequently described event or circumstance occurs at least 75% of the time, at least 80% of the time, at least 90% of the time, at least 95% of the time, or at least 98% of the time.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Where used herein, the pronoun “we” is intended to refer to all persons involved in a particular aspect of the investigation disclosed herein and as such may include non-inventor laboratory assistants and non-inventor collaborators working under the supervision of the inventors.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-30 therefore includes 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30, as well as sub-ranges within the greater range, e.g., for 1-30, sub-ranges include but are not limited to 1-10, 2-15, 2-25, 3-30, 10-20, and 20-30. Reference to a range of 1-50 therefore includes 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30, etc., up to and including 50. Reference to a series of ranges includes ranges which combine the values of the boundaries of different ranges within the series. Thus, to illustrate reference to a series of ranges, for example, a range of 1-1,000 includes, but is not limited to, 1-10, 2-15, 2-25, 3-30, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 1 mm to 10 m therefore refers to and includes all values or ranges of values, and fractions of the values and integers within said range, including for example, but not limited to, 5 mm to 9 m, 10 mm to 5 m, 10 mm to 7.5 m, 7.5 mm to 8 m, 20 mm to 6 m, 15 mm to 1 m, 31 mm to 800 cm, 50 mm to 500 mm, 4 mm to 2.8 m, and 10 cm to 150 cm. Any two values within the range of 1 mm to 10 m therefore can be used to set lower and upper boundaries of a range in accordance with the embodiments of the present disclosure.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

The inventive concepts of the present disclosure will be more readily understood by reference to the following examples and embodiments, which are included merely for purposes of illustration of certain aspects and embodiments thereof, and are not intended to be limitations of the disclosure in any way whatsoever. Those skilled in the art will promptly recognize appropriate variations of the apparatus, compositions, components, procedures and method shown below.

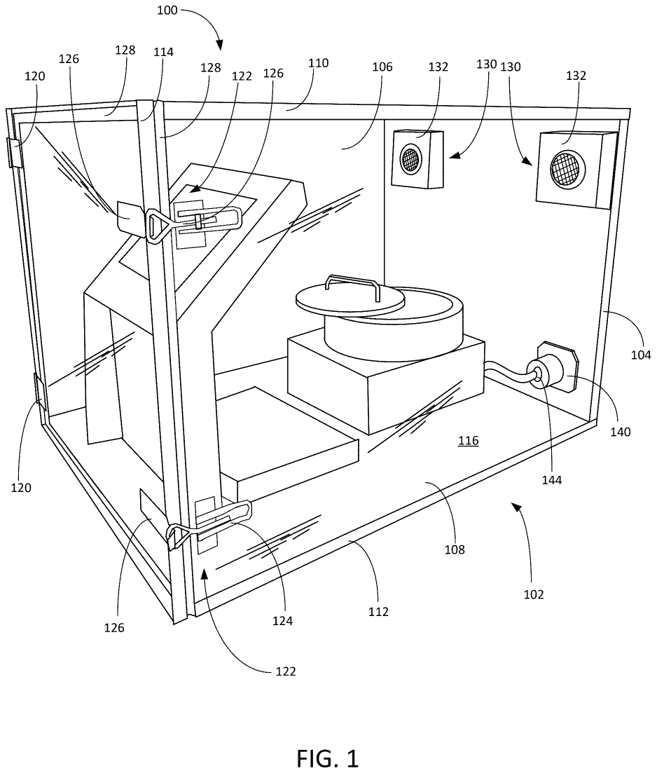

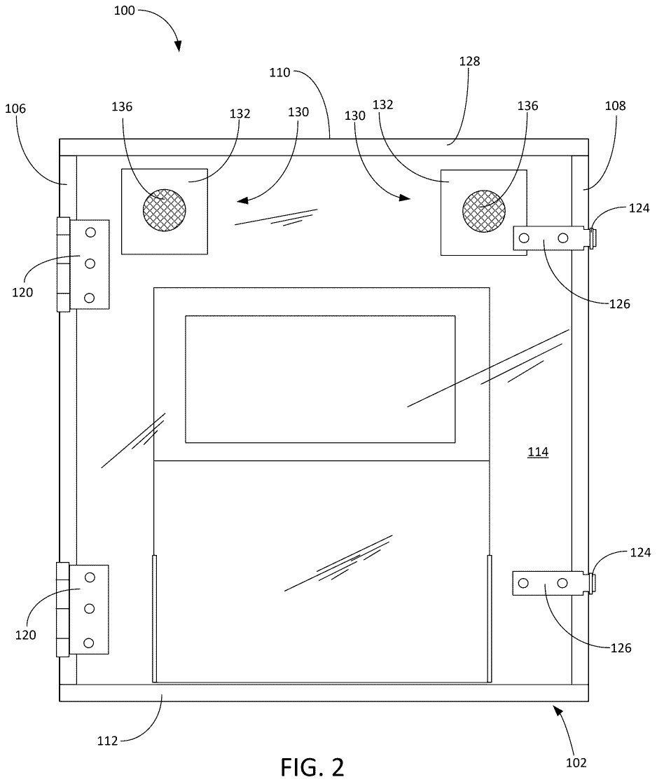

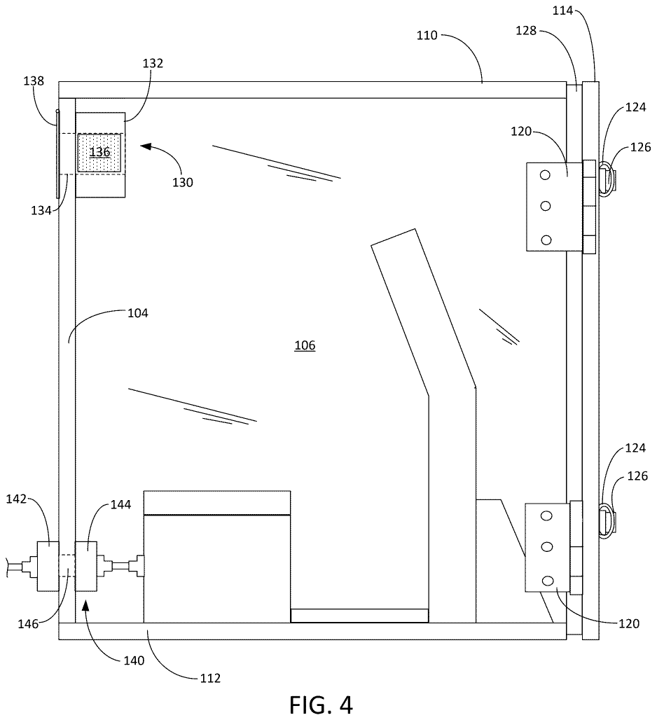

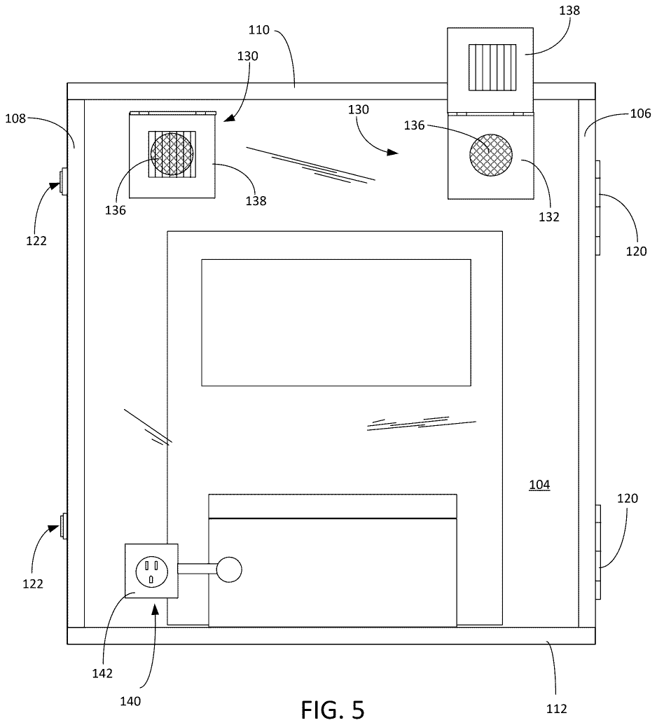

With reference now to FIGS. 1-5, shown therein is the radionuclide containment system 100 constructed in accordance with an exemplary embodiment. The radionuclide containment system 100 is generally configured as a six-sided enclosure 102 that includes a back panel 104, a right side panel 106, a left side panel 108, a top panel 110, a bottom panel 112 and an access panel 114, which together define an enclosure interior 116. In the depicted embodiments, each side of the radionuclide containment system 100 is constructed from a clear acrylic plastic. The acrylic is non-porous and can be easily cleaned with hydrogen peroxide, which is readily available in most cleanrooms. The back panel 104, right side panel 106, left side panel 108, top panel 110 and bottom panel 112 can be connected together with brackets, epoxy, silicon adhesives, or through suitable welding or fusion techniques. The open ends of the right side panel 106, left side panel 108, top panel 110 and bottom panel 112 together present an enclosure opening 118 on the opposite end of the radionuclide containment system 100 from the back panel 104. The enclosure opening 118 is large enough to permit a worker to place one or both hands inside the radionuclide containment system 100 to safely interact with equipment and radiopharmaceutical compounds located in the enclosure interior 116 of the radionuclide containment system 100. In some embodiments, the radionuclide containment system 100 has exterior dimensions of about 18 inches high×18 inches wide×20 inches deep (i.e., 45.7 cm high×45.7 cm wide×50.8 cm deep,). This size enables the radionuclide containment system 100 to accommodate standard-size heating plates or other heating devices and radiation shielding equipment. A sample heater and radiation shield are depicted in FIGS. 1-5.

The access panel 114 is connected to one of the side panels 106, 108 with one or more suitable hinge assemblies 120. The access panel 114 can be opened outward to reveal the enclosure interior 116, or closed to seal the enclosure opening 118. The radionuclide containment system 100 includes a latch system 122 that can be used to secure the access panel 114 in the closed position. In exemplary embodiments, the latch system 122 includes adjustable latch members 124 that engage catch members 126 to exert a compressive spring force that holds the access panel 114 in a tight, sealed position against the enclosure opening 118.

The radionuclide containment system 100 preferably includes a seal or gasket 128 on the enclosure opening 118 that provides a sealing surface for the access panel 114. In exemplary embodiments, the gasket 128 is a hand-formed, heat-resistant (e.g., rated to 750 °C) gapless seal made of a room-temperature-vulcanizing (RTV) silicone rubber that has been applied to the edge surfaces of the enclosure opening 118, a perimeter of the interior surface of the access panel 114, or to both the enclosure opening 118 and the inside of the access panel 114. Once the silicone rubber cures, the formed-in-place gasket 128 fully seals the access panel 114 to the enclosure opening 118. Suitable silicone rubber products are available under the PERMATEX brand and exhibit a strong bond to acrylic while maintaining flexibility for a tight closure with the access panel 114. The gasket 128 is designed to withstand repeated use and exposure to heat generated by the heating plates inside the radionuclide containment system 100.

When the access panel 114 is latched into a closed position, the compressive force applied by the latch system 122 seals the access panel 114 against the compliant gasket 128, thereby eliminating any air gaps and preventing the escape of radioactive material through the enclosure opening. The custom-formed heat-resistant silicone rubber gasket 128 is more effective and durable than standard adhesive rubber seals, particularly in high-heat conditions. A smoke test can be conducted to ensure that the access panel 114 properly seals the radionuclide containment system 100.

The radionuclide containment system 100 further includes an integrated filter 130. The filter 130 includes a filter housing 132 that is secured to an inside surface of the radionuclide containment system 100 over a filter port 134 that extends through a panel of the radionuclide containment system 100. The filter housing 132 includes filter media 136, such as activated charcoal, which traps radioactive material. The filter media 136 can be packaged in a cartridge, bag or other container inside the filter housing 132. The filter 130 is designed to permit the passive flow of gas out of the interior space of the radionuclide containment system 100 through the filter port 134. In a non-limiting embodiment, the filter 130 employs 8×16 mesh, 5% TEDA impregnated carbon trapping cartridges. Each filter housing 132 is sealed from the cleanroom environment and can be easily cleaned. In the depicted embodiments, the filter 130 does not include a motorized fan for drawing air through the filter 130.

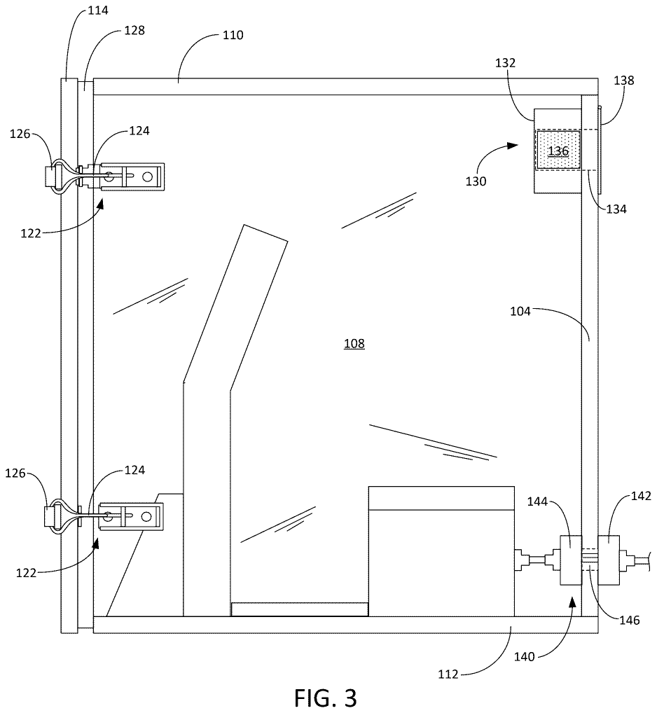

Importantly, as depicted in FIGS. 3-5, the filter 130 includes an external access flap 138 that can be opened from the exterior of the radionuclide containment system 100 so that the filter media 136 can be exchanged from outside the enclosure 102. In some embodiments, the access flap 138 includes a through-hole that permits gas to pass through the access flap 138. In other embodiments, an additional closure flap or cover can be used to seal the access flap 138 to prevent the escape of contaminants from inside the radionuclide containment system 100.

In the depicted embodiments, the radionuclide containment system 100 includes two filters 130 that are located on the back panel 104. It will be appreciated that in other embodiments, one or more filters 130 are positioned elsewhere in the enclosure 102, including on the access panel 114, the right side panel 106, the left side panel 108, the top panel 110, or the bottom panel 112. The filter 130 mitigates pressure differentials that may arise while heating radiopharmaceuticals. In particular, the filter 130 prevents the rapid increase in pressure inside the otherwise sealed radionuclide containment system 100, which may occur if pressurized vial explodes while being heated. If an accident occurs during the preparation of a radiopharmaceutical inside the radionuclide containment system 100, gases released by the radionuclides are permitted to exit the radionuclide containment system 100 in a controlled manner through the filter 130 to prevent the buildup of pressure inside the radionuclide containment system 100.

The radionuclide containment system 100 also includes a sealed electrical power port 140 that extends through one of the panels of the radionuclide containment system 100. The power port 140 includes an exterior adapter 142 that can be connected to a power cord that is connected to a wall power outlet. The power port 140 includes an interior adapter 144 that can be used to connect the power cord of equipment (such as a vial heater or hot plate) inside the radionuclide containment system 100. The power port 140 includes a hermetically sealed electrical bus 146 that carries electricity between the exterior adapter 142 and interior adapter 144. Although a single power port 140 is depicted, it will be appreciated that the radionuclide containment system 100 can include multiple power ports 140 or a power port 140 with multiple power adapters.

The radionuclide containment system 100 contains all radioactive material during an accidental vial breakage while the vial is being heated. In the event of a radiopharmaceutical preparation accident in which radioactive materials are released from vials or other preparation containers, the radioactive material is contained within the radionuclide containment system 100 and instead of evacuating the entire laboratory space for a multiday decay period, personnel can simply set the disclosed containment system aside and continue to work in the lab space “as usual” as the radioactive material decays within the radionuclide containment system 100. The decrease in radioactive contamination decreases radioactive exposure to personnel and allows the safe operation of the pharmacy or laboratory to continue. The radionuclide containment system 100 is small enough to be easily removed to a shielded area for decay, while a backup containment system can take its place to minimize down time. The radionuclide containment system 100 is compliant with cleanroom standards and segregated compounding area standards.

While the present disclosure has been described herein in connection with certain embodiments so that aspects thereof may be more fully understood and appreciated, it is not intended that the present disclosure be limited to these particular embodiments. On the contrary, it is intended that all alternatives, modifications, and equivalents are included within the scope of the present disclosure as defined herein. Thus the embodiments described above, which include particular embodiments, will serve to illustrate the practice of the inventive concepts of the present disclosure, it being understood that the particulars shown are by way of example and for purposes of illustrative discussion of particular embodiments only and are presented in the cause of providing what is believed to be the most useful and readily understood description of methods and procedures as well as of the principles and conceptual aspects of the present disclosure. Changes may be made in the apparatus, components, systems, and methods described herein, or in the steps or the sequence of steps of the methods described herein, without departing from the spirit and scope of the present disclosure. Further, while various embodiments of the present disclosure have been described in exemplary claims herein below, it is not intended that the present disclosure be limited to these particular exemplary claims.

It is claimed:

1. A radionuclide containment system comprising:
an enclosure, wherein the enclosure comprises:
an enclosure opening;
an access panel that controls access through the enclosure opening; and
an enclosure interior;
a filter connected to the enclosure; and
a power port connected to the enclosure.

2. The radionuclide containment system of claim 1, wherein the enclosure further comprises a back panel, a right side panel, a left side panel, a top panel and a bottom panel.

3. The radionuclide containment system of claim 2, wherein the enclosure is manufactured from a non-porous acrylic.

4. The radionuclide containment system of claim 3 further comprising a gasket between the enclosure opening and the access panel.

5. The radionuclide containment system of claim 4, wherein the gasket is manufactured from a silicone rubber.

6. The radionuclide containment system of claim 1, further comprising one or more hinge assemblies that permit the access panel to swing outward to an open position that reveals the enclosure interior.

7. The radionuclide containment system of claim 6, further comprising a latch system for securing the access panel in a closed position against the enclosure opening.

8. The radionuclide containment system of claim 1, wherein the filter comprises:
a filter housing; and
filter media inside the filter housing.

9. The radionuclide containment system of claim 8, wherein the filter media is activated charcoal.

10. The radionuclide containment system of claim 8, wherein the enclosure comprises a filter port that extends through the enclosure and wherein the filter housing is connected to enclosure at the filter port.

11. The radionuclide containment system of claim 10, wherein the filter housing comprises an external access flap that permits exchange of the filter media from within the filter housing from outside the enclosure.

12. The radionuclide containment system of claim 11, wherein the radionuclide containment system comprises a plurality of filters.

13. The radionuclide containment system of claim 1, wherein the power port comprises:
an exterior adapter configured for connection to a power cord connected to a wall outlet;
an interior adapter configured for connection to a power cord for equipment located in the enclosure interior; and
a hermetically sealed electrical bus between the exterior adapter and the interior adapter.

14. The radionuclide containment system of claim 13, wherein the enclosure is constructed without openings though which a user can use gloved hands to manipulate an object within the enclosure interior.

15. A radionuclide containment system comprising:
an enclosure, wherein the enclosure comprises a back panel, a right side panel, a left side panel, a top panel and a bottom panel;
an enclosure opening opposite the back panel, wherein the enclosure opening is formed by the open ends of the back panel, the right side panel, the left side panel and the top panel;
an access panel that controls access through the enclosure opening;
a gasket between the access panel and the enclosure opening;
a filter connected to the back panel; and
a power port connected to the back panel.

16. The radionuclide containment system of claim 15, wherein the enclosure is manufactured from a non-porous acrylic.

17. The radionuclide containment system of claim 15, wherein the gasket is manufactured from a room-temperature-vulcanized silicone rubber.

18. The radionuclide containment system of claim 15, further comprising:
one or more hinge assemblies that permit the access panel to swing outward away from the enclosure opening to an open position; and
a latch system for securing the access panel in a closed position against the enclosure opening.

19. The radionuclide containment system of claim 15, wherein the filter comprises:
a filter housing;
filter media inside the filter housing; and
an exterior access flap.

20. The radionuclide containment system of claim 15, wherein the power port comprises:
an exterior adapter configured for connection to a power cord connected to a wall outlet;
an interior adapter configured for connection to a power cord for equipment located in the enclosure interior; and
a hermetically sealed electrical bus between the exterior adapter and the interior adapter.
